(19) United States
(12) Patent Application Publication
(10) Pub. No.: US 2009/0114473 A1
(43) Pub. Date: May 7, 2009

(54) SHEAR WAVE GENERATOR

(75) Inventors: Harald Westerdahl, Dal (NO); Per Sparrevik, Oslo (NO); Christian Madshus, Oslo (NO)

Correspondence Address: SENNIGER POWERS LLP, 100 NORTH BROADWAY, 17TH FLOOR, ST LOUIS, MO, 63102, US

(73) Assignee: NGI, Oslo (NO)

(21) Appl. No.: 11/719,579

(22) PCT Filed: Nov. 16, 2005
(86) PCT No.: PCT/NO05/00430

§ 371 Date: Dec. 24, 2008

(30) Foreign Application Priority Data
Nov. 19, 2004 (NO) 2004 5036

(51) Int. Cl. G01V 1/04

(52) U.S. Cl. 181/119

(57) ABSTRACT

A shear wave generator for use subsea, including an excitation unit that is fastened to a top plate; a skirt, the upper end of which is fastened sealingly to the top plate and extending downward to an open lower end of the skirt, such that the top plate and skirt form a closed space by lowering to the seabed; and a pump arranged with fluid communication between the space and the surroundings, such that by pumping water out of the space, an underpressure is formed acting to suck the shear wave generator fixedly to and partly into the seabed, and by pumping water into the space, an overpressure is formed acting to lift the shear wave generator up from the seabed. The shear wave generator is distinguished in that the skirt is formed with a larger outer diameter or width at its upper end than at its lower end.

### FIELD OF THE INVENTION

The present invention relates to a shear wave generator for use subsea for seismic explorations. More particularly, the invention relates to a shear wave generator, i.e. a seismic seabed coupler, integrated with a suction anchor, the shear wave generator being particularly beneficial for repeated use on seabed of various nature.

### BACKGROUND OF THE INVENTION AND PRIOR ART

Shear waves are often used for seismic explorations, as shear waves have preferable properties compared to pressure waves. Shear waves do not propagate through liquid and gas, for which reason a subsea shear wave generator must be coupled mechanically to the seabed. This can be achieved by fastening the shear wave generator to means that have been penetrated into the seabed, for example piles, as described in Norwegian Patent Publication NO 304203. The shear wave generator can alternatively be arranged connected with a suction anchor, as described in Norwegian Patent Publication NO 310747.

A shear wave generator should have as good mechanical coupling to the seabed as possible for better transmission of shear waves into the underground. Another and somewhat contradicting acquirement for a shear wave generator is that it can advantageously be taken up from the position on the seabed for removal to another location, which can be difficult if the shear wave generator is permanently fixed or if the suction anchor is deeply fastened into the seabed.

Suction anchoring functions with a pump arranged with fluid communication to a closed space, the pump acting by sucking water out of the closed space generating underpressure such that the closed space constituting a part of the suction anchor is sucked into the seabed. If water is pumped into said closed space, overpressure is generated, which helps to bring the suction anchor up from the seabed.

It has proved to be a demand for a shear wave generator with improved suction anchoring, so as to improve functionality for different types of seabed, particularly soft seabed, while uptake of the suction anchored shear wave generator advantageously can be improved. It is an objective of the present invention to provide an improved shear wave generator in that respect.

### SUMMARY OF THE INVENTION

With the present invention a shear wave generator is provided for use under water, comprising:

an excitation unit that is fastened to

a top plate

a skirt that at an upper end is fastened sealingly to the top plate, extending to an open lower end of the skirt, so that the top plate and the skirt form a closed space at lowering on the seabed, and

a pump arranged with fluid communication between said space and the surroundings, such that by pumping water out of said space an underpressure is formed acting to suck the shear wave generator fixedly to and partly into the seabed, and by pumping water into said space an overpressure is formed acting to lift the shear wave generator up from the seabed. The shear wave generator is distinguished in that the skirt is formed with larger outer diameter or width at its upper end than at its lower end.

With the shear wave generator according to the invention an improved contact with the surrounding seabed is achieved, because the form of the skirt results in that the seabed is compacted as the skirt penetrates into the seabed, which is preferable, particularly for soft seabed. Further, uptake of the skirt from the seabed is facilitated, because of the form of the skirt.

With the term excitation unit a device able to generate seismic shear waves is meant. The excitation unit can for example be a mass moved hydraulically in the horizontal plane such that shear waves are formed in the direction vertical below the shear wave generator. With the term top plate is meant mainly a mechanical sealing at the upper edge of the skirt, for providing a closed space. The top plate is preferably a plate, but can have another form such as a half sphere, a pyramid or a plate with a depression for the movable mass of the excitation unit. The excitation unit is fastened to the top plate, i.e. on top, under or both, and the excitation unit can in addition be fastened to the underlying skirt via cross girders. The skirt is a wall extending downward from the top plate, and is to be lowered down to and preferably into the seabed with the lower end of the skirt. The skirt can be like a pipe, of which the inner diameter can be constant over the length, as a cylindrical pipe, while the outer diameter according to the distinguishing feature of the invention is larger at the upper end of the skirt. With the term fluid communication it is meant a way for fluid flow connected to a pump in order to to pump water into or out of the closed space delimited by the top plate, the skirt and the seabed. The pump can be arranged in connection with a hole in the top plate or the skirt. With the skirt being formed with larger diameter or width at its lower end than at its upper end, it is referred to the outer diameter or width of the skirt, which width or diameter accordingly is larger in the upper end. The lower end of the skirt can have even or equal diameter or width. With the term “sucking the shear wave generator fixedly to and partly into the seabed”, it is meant fastening from zero penetration on very hard substructures, to maximum penetration of the shear wave generator into very soft substructure, which maximum penetration can be limited by optional means stopping further penetration.

The skirt has preferably the form of a conical pipe or an inverse cone section, with evenly increasing, progressively increasing or stepwise increasing diameter up to its upper end, or the skirt has form of a rectangle or a polygon, for example an inverse pyramid, with evenly increasing, progressively increasing or stepwise increasing diameter up to its upper end. The inner diameter of the skirt can preferably be constant along the length to facilitate uptake of the skirt, while the outer diameter or width is larger in the upper end such that a wedge form according to the invention is provided. The width or diameter of the skirt is preferably approximately similar or larger than the height of the skirt, to provide a preferable low centre of gravity.

A valve and instrumentation for pressure control is preferably arranged with the pump to facilitate operation. For example pressure transmitters inside the closed space and outside can be used to control the speed of the pump, the valve position or whether or not the pump shall be in operation, to maintain an intended differential pressure.

An outer stop flange is preferably arranged on the outside of the skirt, at the height for maximum penetration into the seabed, to hinder unintended further penetration. The skirt preferably has the form of a concave cone, of which the upper part towards the top plate is approximately horizontal, thereby functioning as a stopping plate.

An inner framework is preferably arranged uppermost in said closed space, for reinforcement and ensuring that a sufficient closed space under the top plate is maintained.

The skirt has preferably longitudinal fluid passage ways in the wall of the skirt, with the outlet in the lower end of the skirt, so that the skirt wall is hollow and water can be pumped out from perforations arranged around the lower end of the skirt. Thereby lowering and uptake of the shear wave generator is facilitated, because the resistance of the seabed is actuated.

The excitation unit is preferably provided with means for rotation into the horizontal plane, for example ±90°, to provide more complete seismic signals.

The shear wave generator can preferably be provided with a removable outer flexible cap extending further down than the lower end of the skirt, to facilitate fastening on uneven and/or hard under layers.

The excitation unit is preferably fastened to both the top plate and the skirt, the excitation unit being recessed down from the top plate to a lower level for a framework that is arranged into the skirt between the recession and skirt. In that way a strong construction with a low centre of gravity is provided.

### DRAWINGS

The present invention is illustrated with five drawings, of which:

FIG. 1 is a section of a shear wave generator according to the invention,

FIG. 2 illustrates normal installation of the shear wave generator according to the invention,

FIG. 3 illustrates installation through hard layers of the shear wave generator according to the invention,

FIG. 4 illustrates uptake from the seabed of the shear wave generator according to the invention, and

FIG. 5 illustrates the shear wave generator according to the invention, during operation.

### DETAILED DESCRIPTION

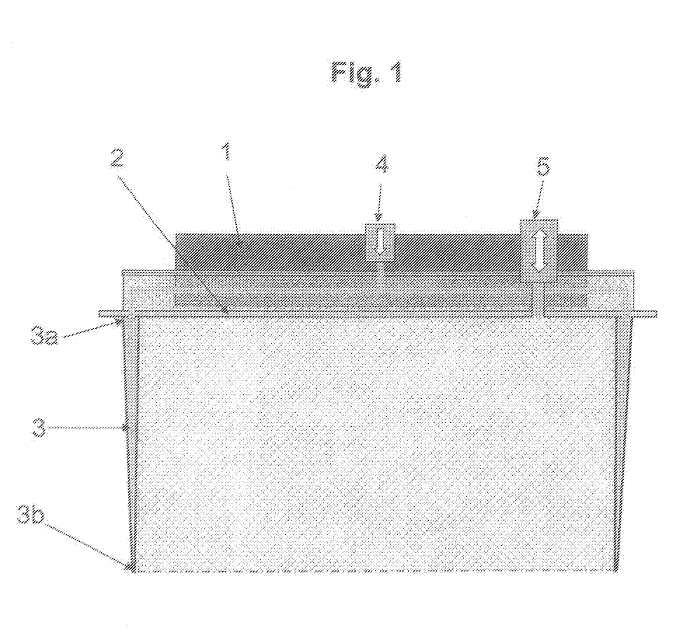

Reference is first made to FIG. 1 illustrating a shear wave generator according to the invention. More particularly, an excitation unit 1 is illustrated as fastened to a top plate 2, under which top plate a skirt 3 is provided, extending downward. The skirt has an upper end 3a that is fastened to the top plate and a lower end 3b that is to be arranged against the seabed. Further, a pump 5 is illustrated, which is used to pump water out from or into the closed space, respectively, for sucking the seabed generator fixedly to and partly into the seabed, or providing an overpressure acting to lift the shear wave generator up from the seabed. A further pump 4 is illustrated, which can be used to pump water out from the lower end of the skirt, which can be beneficial both during installation and uptake of the shear wave generator.

As appearing from FIG. 1, the skirt is formed with a concentric form with increasing outer diameter up towards the upper end 3a. In the illustrated embodiment the inner diameter of the skirt is constant, while the outer diameter is evenly increasing to the upper end of the skirt.

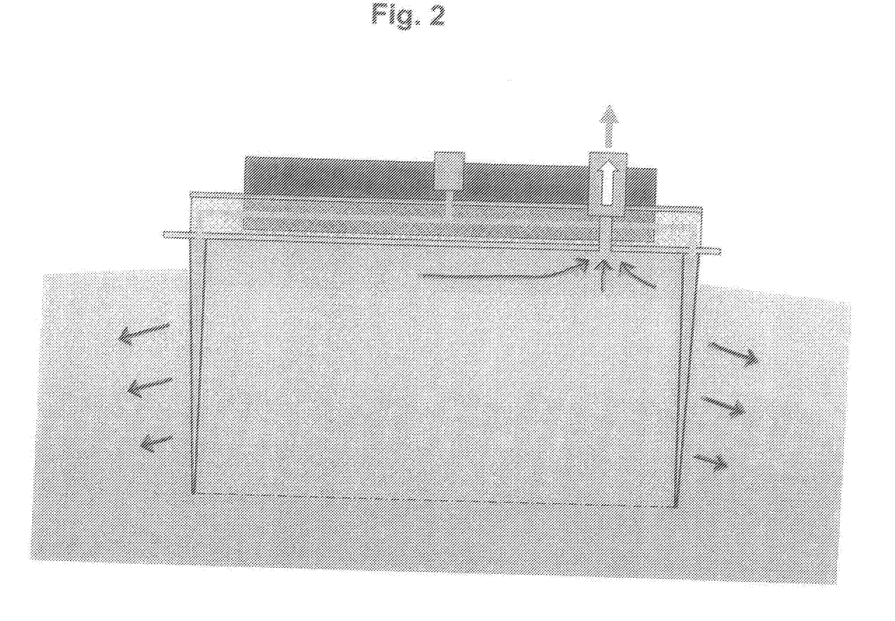

Further reference is made to FIG. 2, illustrating installation of the shear wave generator according to the invention, by use of the pump 5. More particularly, it is illustrated with arrows how the surrounding seabed because of the increasing diameter towards the upper end of the skirt becomes compacted as the shear wave generator penetrates into the seabed. Said compacting results in increased sideway pressure on the seabed on the outside of the skirt. The coupling and energy transfer to the seabed are therefore improved. The seabed is displaced outwards as the skirt is lowered into the seabed, preferably to a level providing an appropriate intermediate space between the seabed and the top plate. The wedge like form of the skirt will minimize further penetration because of vibration during operation of the excitation unit.

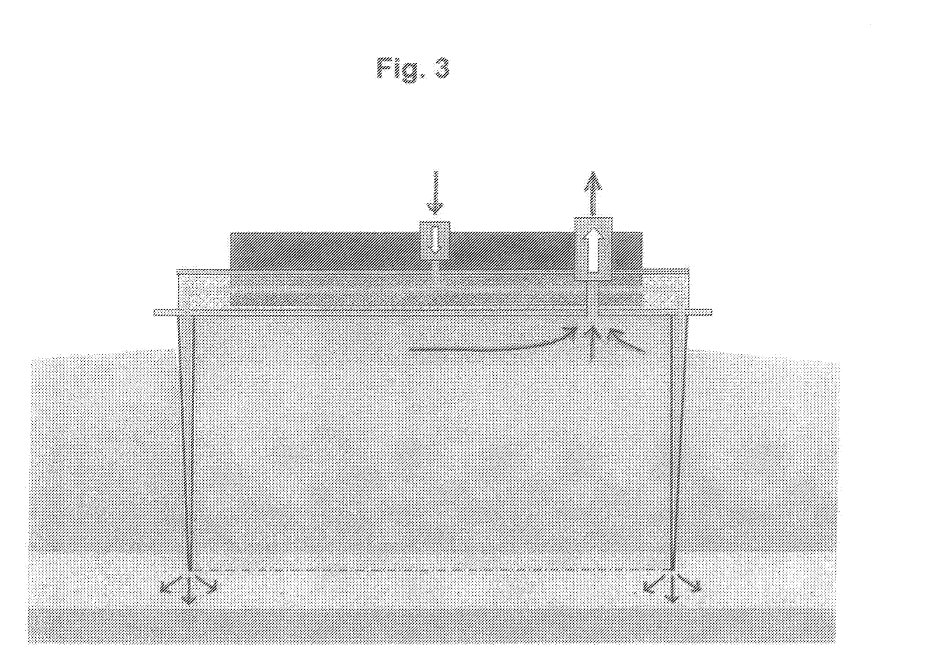

Reference is made to FIG. 3 illustrating a preferable embodiment of the shear wave generator of the invention, with an internally hollow skirt. The space in the skirt thereby formed is in fluid communication with the pump 4, as previously mentioned, such that water in a controlled way can be pumped out from perforations in the lower end of the skirt. The pump 5 can optionally be arranged to provide similar function. In that way the resistance acting against penetration into the seabed is reduced, which is particularly beneficial in layers of sand where it can be possible to provide a liquid-like consistency.

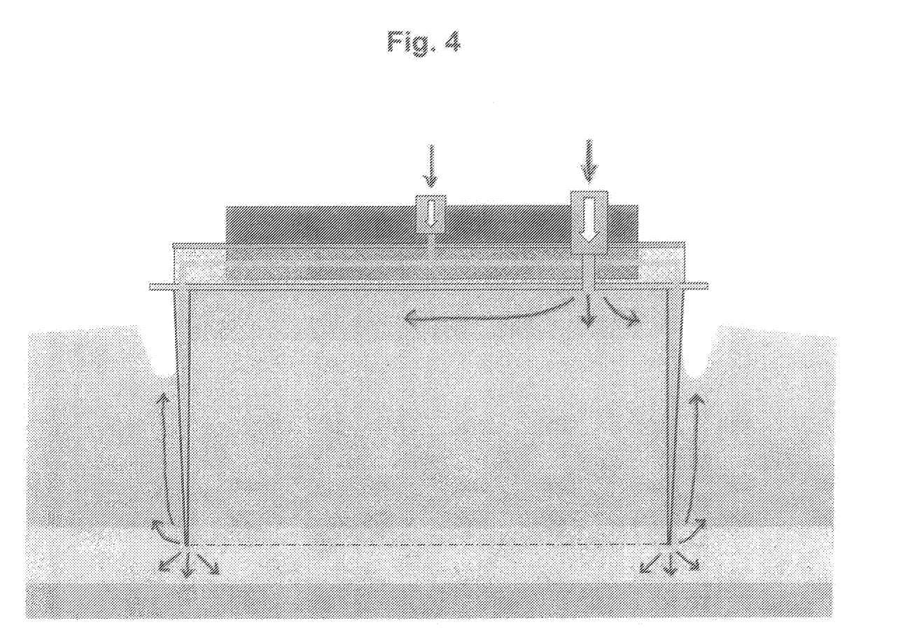

Reference is further made to FIG. 4 where uptake from the seabed of the shear wave generator is illustrated. By pumping water into the closed space under the top plate, an overpressure is generated assisting in pressing the skirt up from the seabed. Simultaneously, water can be pumped into the hollow skirt and out from the perforations in the lower end of the skirt in order to reduce resistance against uptake from the seabed. The water flows are illustrated with arrows on the figure.

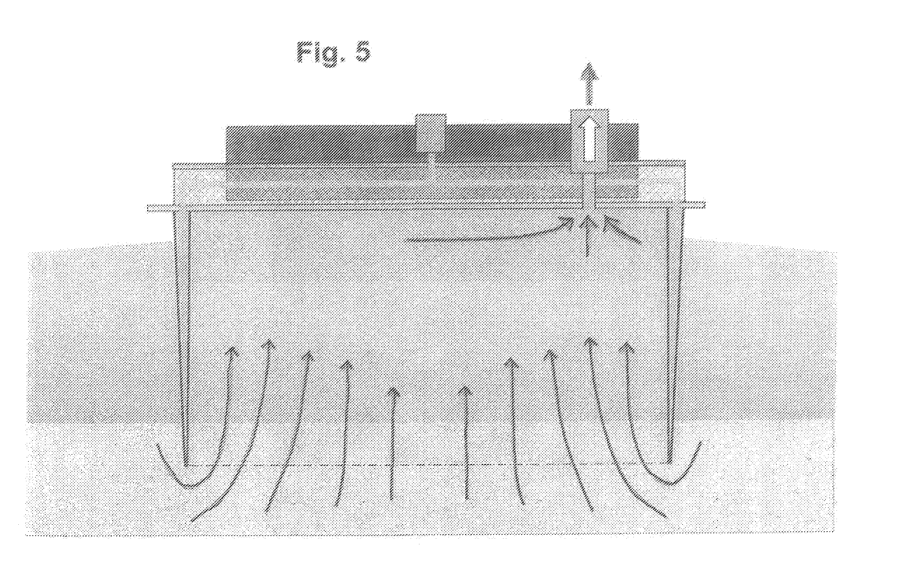

Reference is made to FIG. 5 where operation of the shear wave generator is illustrated, with constant underpressure into and around the skirt of the shear wave generator by means of controlled pumping out of water from the closed space within the shear wave generator. The pumping out of water is preferably pressure controlled to an appropriate underpressure. On a sandy seabed it is particularly advantageous to keep an underpressure during operation, in order to hinder seabed-softening due to pore pressure accumulation of the vibrations. The stiffness of the seabed increases because of the negative pore pressure. Increased stiffness in the seabed results in better coupling of the seismic waves to the seabed.

The excitation unit is operated while the shear wave generator is fixedly fastened to the seabed.

1. Shear wave generator for use subsea, comprising:
an excitation unit that is fastened to
a top plate
a skirt that at an upper end is fastened sealingly to the top plate and extending downward to an open lower end of the skirt, such that the top plate and skirt form a closed space at lowering on the seabed, and
a pump arranged with fluid communication between said space and the surroundings, such that by pumping water out of said space underpressure is formed acting to suck the shear wave generator fixedly to and partly into the seabed, and by pumping water into said space overpressure is formed acting to lift the shear wave generator up from the seabed wherein the skirt is formed with larger outer diameter or width at its upper end than at its lower end.

2. Shear wave generator according to claim 1, wherein the skirt has form of a conical pipe or an inverse cone section, with evenly increasing, progressively increasing or stepwise increasing diameter up to its upper end.

3. Shear wave generator according to claim 1, wherein the skirt has form of a rectangle or polygon, for example an inverse pyramid, with evenly increasing, progressively increasing or stepwise increasing diameter up to its upper end.

4. Shear wave generator according to claim 1, wherein the width or diameter of the skirt is approximately even or larger than the height of the skirt.

5. Shear wave generator according to claim 1, wherein a valve and instrumentation for pressure control are arranged with the pump.

6. Shear wave generator according to claim 1, wherein an outer stop flange is arranged on the outside of the skirt, at the height for maximum penetration into the seabed.

7. Shear wave generator according to claim 1, wherein an inner framework is arranged uppermost in said closed space, for reinforcement and to ensure that a sufficient closed space under the top plate is maintained.

8. Shear wave generator according to claim 1, wherein the skirt has longitudinal fluid passage ways in the wall of the skirt, with outlet at the lower end of the skirt, such that the skirt wall is hollow and water can be pumped out of perforations arranged around the lower end of the skirt.

9. Shear wave generator according to claim 1, wherein the skirt has form of a concave cone, the upper part thereof towards the top plate being approximately horizontal.

10. Shear wave generator according to claim 1, wherein the excitation unit is provided with means for rotation in the horizontal plane, for example ±90°.

11. Shear wave generator according to claim 1, wherein it is equipped with a removable, flexible cap extending further down than the lower end of the skirt, to facilitate fastening on uneven and/or hard underlayers.

12. Shear wave generator according to claim 1, wherein the excitation unit is fastened both to the top plate and the skirt, the excitation unit being recessed from the top plate to a lower level for a framework which is arranged within the skirt between the recession and the skirt.
